(19) United States
(12) Patent Application Publication
(10) Pub. No.: US 2007/0095603 A1
(43) Pub. Date: May 3, 2007

(54) Belt-type electric power steering apparatus

(75) Inventors: Joo Namgung, Wonju-si (KR); Heegwon Jo, Gunpo-si (KR)

Correspondence Address: LAHIVE & COCKFIELD, LLP, ONE POST OFFICE SQUARE, BOSTON, MA, 02109-2127, US

(73) Assignee: Mando Corporation, Pyeongtaek-si (KR)

(21) Appl. No.: 11/544,540

(22) Filed: Oct. 6, 2006

(30) Foreign Application Priority Data
Oct. 25, 2005 (KR) 2005-0100983

(51) Int. Cl. B62D 5/04

(52) U.S. Cl. 180/444

(57) ABSTRACT

Disclosed is a belt type electric power steering apparatus, the apparatus comprising: a gearbox housing enclosing a rack gear and a ball screw; a motor pulley housing coupled to the gearbox housing and enclosing an electric motor, a belt for transmitting rotational force of the electric motor to a rack bar; and locking washers interposed between bolt heads and the gearbox housing, for preventing loosening of bolts when the motor pulley housing is coupled to the gearbox housing.

### RELATED APPLICATION

This application claims convention priority to Korean patent application. No. 2005-0100983filed on Oct. 25, 2005, the content of which is incorporated by reference.

### FIELD OF THE INVENTION

The present invention relates to a belt-type electric power steering apparatus. More particularly, the present invention relates to a belt-type electric power steering apparatus, in which a motor pulley housing and a gearbox housing are coupled by bolts and release of the bolts is prevented, thereby preventing the droop of the motor pulley housing.

### DESCRIPTION OF THE PRIOR ART

Generally, hydraulic power steering apparatuses using hydraulic pressure of a hydraulic pump have been used as power steering apparatuses for vehicles. Since the 1990's, electric power steering apparatuses using an electric motor have been eventually popularized.

In a conventional hydraulic steering apparatus, a hydraulic pump, which is a power source assisting power for the hydraulic steering apparatus, is operated by an engine of a vehicle, and always consumes energy regardless of the rotation of a steering wheel. In an electric power steering apparatus, on the other hand, if a steering wheel rotates and generates torque, an electric motor which is operated by electric energy provides steering assistant power. Therefore, when the electric power steering apparatus is used, it is possible to improve energy efficiency in comparison with the hydraulic power steering apparatus.

FIG. 1 is a schematic view showing a configuration of a conventional electric power steering apparatus for a vehicle.

As shown in FIG. 1, the conventional electric power steering apparatus includes a steering system 100 extending from a steering wheel 101 to both wheels 108, and an assistant power mechanism 120 for providing steering power.

The steering system 100 includes a steering shaft having an end connected to the steering wheel 101 to rotate along with the steering wheel 101, and the other end connected to a pinion shaft 104 by a pair of universal joints 103. Further, the pinion shaft 104 is connected to a rack bar 109 through a rack-pinion mechanism 105, while both ends of the rack bar 109 are connected to both wheels of the vehicle by tie rods 106 and knuckle arms 107, respectively.

The rack-pinion mechanism 105 has a pinion gear 111 mounted on the pinion shaft 104, and a rack gear 112 mounted on a peripheral surface of one end of the rack bar 109 and engaged with the pinion gear 111. When a driver operates the steering wheel 101, torque is generated in the steering system 100 and causes the rack-pinion mechanism 105 and the tie rods 106 to steer the wheels 108.

The assistant power mechanism 120 includes a torque sensor 121 for sensing torque applied to the steering wheel 101 by the driver, so as to output an electric signal in proportion to the sensed torque, an electronic control unit 123 for generating a control signal depending on the electric signal transmitted from the torque sensor 121, an electric motor 130 for generating steering power according to the control signal transmitted from the electronic control unit 123, and a belt-type power transmission apparatus 140 for transmitting the assistant power, generated by the electric motor 130, to the rack bar 109 through the belt.

Accordingly, in the electric power steering apparatus, the torque generated by the rotation of the steering wheel 101 is transmitted through the rack-pinion mechanism 105 to the rack bar 109. The assistant steering power which the electric motor 130 generates depending on the generated torque, is transmitted by the belt-type power transmission apparatus through a ball screw 150 to the rack bar 109. In other words, the rack bar is moved along an axis thereof by the torque generated in the steering system 100 and the assistant power generated by the electric motor 130.

FIG. 2 is a sectional view showing the conventional electric power steering apparatus for a vehicle.

As shown in FIG. 2, the conventional power steering apparatus for the vehicle includes the rack bar 109 extending across the vehicle and having the rack gear mounted on an outer peripheral surface thereof, the pinion shaft 104 having the pinion gear engaged with the rack gear, the ball screw unit 150 having balls 210, a ball screw 203, and a ball nut 205 engaged with the ball screw 203 through the balls 201, the belt-type power transmission apparatus 140 connecting the ball nut 205 to the shaft 221 of the electric motor, and the electric motor 130. Further, a motor pulley housing 240 encloses the electric motor and is fixed to a gearbox housing 250 by a bolt coupling.

The pinion shaft 104 is connected to the steering wheel through the steering shaft, and the rack bar 109 having the screw formed by a predetermined length at one end thereof is contained in a rack housing 223.

The ball screw unit 150 includes the ball nut 205 formed to be coaxial with the rack bar 109 and enclosing the rack bar 109, and the balls 201 arranged on the outer peripheral surface of the rack bar 109 and contacting the ball screw 203. The ball nut 205 rotates as the motor shaft 221 rotates. A bearing 207 is interposed between the outer surface of the ball nut 205 and the inner surface of the rack housing 223 in order for the ball nut 205 to rotate smoothly.

The belt type power transmission apparatus 140 includes a belt 230 connecting the motor shaft 221 to the ball nut 205, and transmits steering power generated from the electric motor 130 in proportion to the steering torque applied to the steering wheel to the rack bar 109 through the ball nut 205. In other words, as the motor shaft 221 rotates, the ball nut 205 rotates by receiving the rotational force of the motor shaft 221 through the belt 230. When the ball nut 205 rotates, the rack bar 109 straightly moves in a direction of the axis of the rack bar 109.

FIG. 3 is a side view showing a motor pulley housing and gearbox housing for the conventional electric power steering apparatus of the vehicle.

The motor is fixed to the gearbox housing 250 by coupling the motor pulley housing 240 to the gearbox housing 250 using the bolts. During the steering of the wheels, the motor 221 rotates to operate the belt 230, causing the ball nut 205 to rotate. Thus, the tension of the belt 230 is applied to the motor shaft 221 and the rack bar 109 provided with the ball nut 205 so that the force of the motor shaft 221 and the rack bar 109 pulls the motor shaft 221 and the rack bar 109 toward each other. The force concentrates on the bolt coupling portion of the pulley housing 240 and the gearbox housing 250 which is mechanically weakened. Further, during the steering of the wheels, the motor shaft 221 rotates while generating vibration and impact, etc. to cause loosening of the bolts. As a result, there is a disadvantage in that the motor shaft 221 moves in a direction to the rack bar 105 provided with the ball nut 205 so as to reduce the tension of the belt 230, thereby causing noise between the belt 230 and the pulley, as well as damaging the belt 230.

### SUMMARY OF THE INVENTION

Accordingly, the present invention has been made to solve the above-mentioned problems occurring in the prior art, and it is an object of the present invention to provide a belt type electric power steering apparatus, which has the combination structure of the motor pulley housing capable of preventing loosening of the bolts and the deflection of the motor pulley housing when the motor pulley housing is coupled to a gearbox housing by means of bolts.

In order to accomplish an object of the present invention, there is provided a belt type electric power steering apparatus, the apparatus comprising: a gearbox housing enclosing a rack gear and a ball screw; a motor pulley housing coupled to the gearbox housing and enclosing an electric motor, a belt for transmitting rotational force of the electric motor to a rack bar, and locking washers interposed between bolt heads and the gearbox housing, for preventing loosening of bolts when the motor pulley housing is coupled to the gearbox housing.

### BRIEF DESCRIPTION OF THE DRAWINGS

The above and other objects, features and advantages of the present invention will be more apparent from the following detailed description taken in conjunction with the accompanying drawings, in which:

FIG. 1 is a schematic view showing a configuration of a conventional electric power steering apparatus for a vehicle;

FIG. 2 is a sectional view showing the conventional electric power steering apparatus for a vehicle;

FIG. 3 is a side view showing a motor pulley housing and a gearbox housing for the conventional electric power steering apparatus of the vehicle;

FIG. 4 is a partial sectional view of a portion marked by ellipse B in FIG. 3, according to the first embodiment of the present invention;

FIG. 5A is a front view of a portion marked by ellipse B in FIG. 3, according to the second embodiment of the present invention;

FIG. 5B is a side view of a portion marked by ellipse B in FIG. 3, according to the second embodiment of the present invention; and

FIG. 6 shows washers used for preventing loosening of bolts shown in FIGS. 4 and 5B.

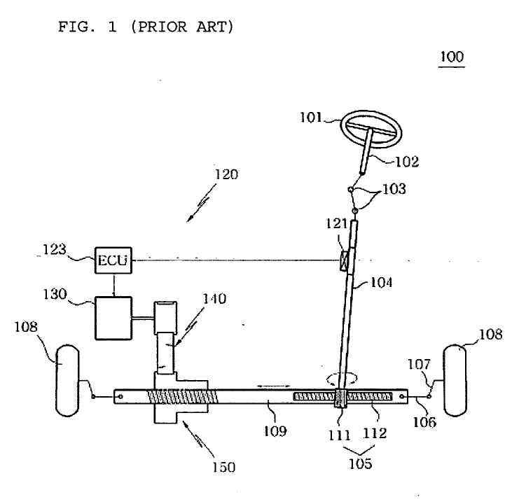

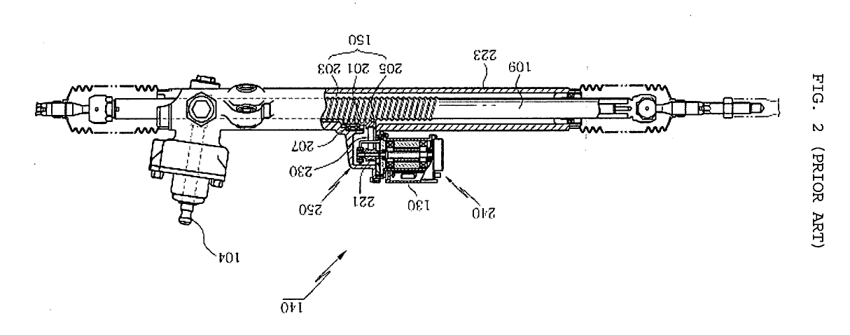

### DETAILED DESCRIPTION OF THE PREFERRED EMBODIMENTS

Hereinafter, the embodiments of the present invention will be described with reference to the accompanying drawings. In the following description and drawings, the same reference numerals are used to designate the same or similar components, and so repetition of the description on the same or similar components will be omitted.

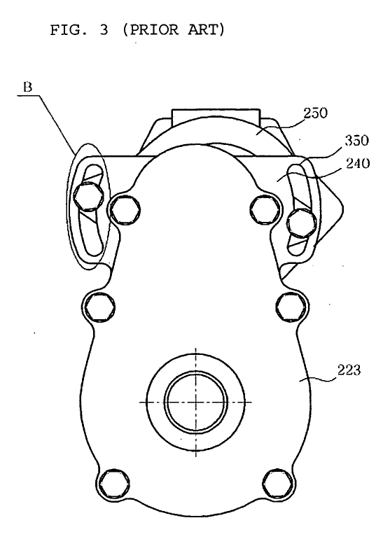

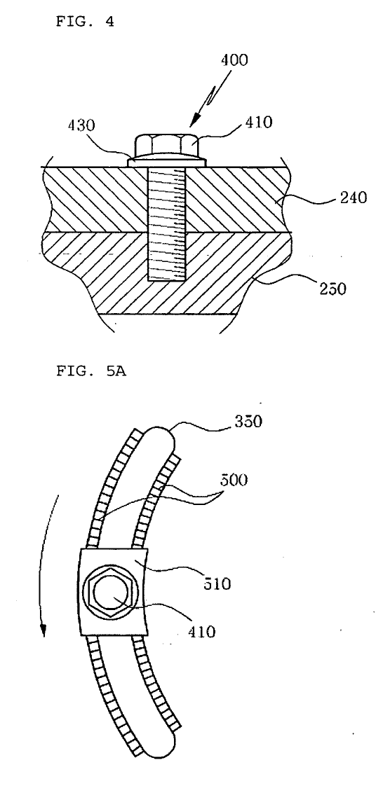

FIG. 4 is a partial sectional view of a portion marked by ellipse B in FIG. 3, according to the first embodiment of the present invention. In FIG. 4, the combination of a motor pulley housing 240 and a gearbox housing 250 by means of bolts is shown, in which a locking washer 430 is interposed between a bolt head 410 and the gearbox housing 250.

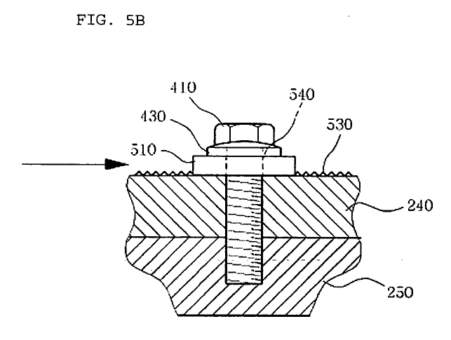

FIG. 5A is a front view of a portion marked by ellipse B in FIG. 3, according to the second embodiment of the present invention, and FIG. 5B is a side view of a portion marked by ellipse B in FIG. 3, according to the second embodiment of the present invention.

The tension of the belt 230 causes force to be applied to the motor pulley housing 240, mounted on and fixed to the gearbox housing 250 by means of the bolts, in a direction marked by an arrow in FIG. 5B. The first prominence 500 is formed at both edges of a guide hole 350 in order to prevent the movement of the motor pulley housing 240 in the direction marked by the arrow in FIG. 5B. A block-shaped washer 510 is disposed between the bolt head 410 and the gearbox housing 250, and has the second prominence 530 formed on a surface thereof, and a hole for the bolt formed at a center portion thereof. The locking washer 430 is interposed between the bolt head 410 and the block-shaped washer 510 so as to prevent movement of the motor pulley housing 240 by the first prominence 500 formed at both edges of the bolt guide hole 350 of the gearbox 250 and the second prominence 530 formed on the block-shaped washer 510. Further, the locking washer 430 is interposed between the bolt head 410 and the block-shaped washer 510, so as to prevent the bolt 400 from being loosened due to vibrations generated during the operation of the vehicle.

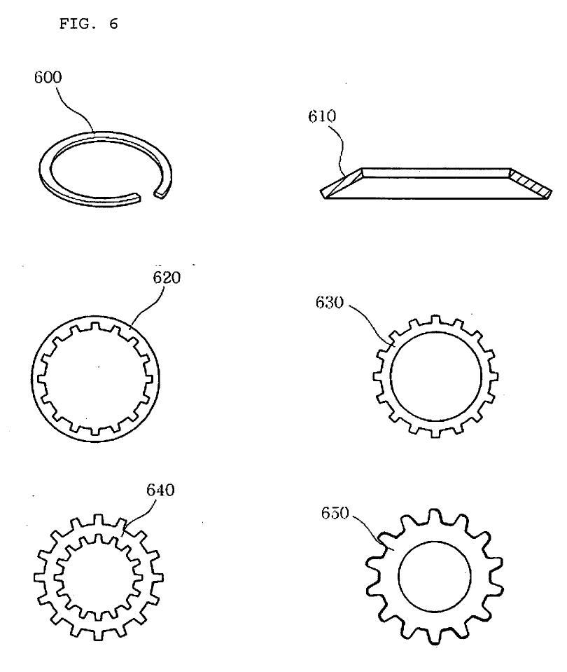

FIG. 6 shows washers used for preventing loosened of bolts shown in FIGS. 4 and 5B.

The washers are generally used to prevent the bolt head or nut from damaging the object to be coupled caused by the coupling force of the bolt or nut, or to prevent the coupled bolt or nut from being loosened by mechanical vibrations.

Doughnut-shaped plan washers made of a metal material are generally used as washers to prevent the damage of the material. Following washers, for example C-type spring washer 600 made by cutting a portion of a coil spring, a disc spring washer 610 with a disc shape, an inner tooth washer 620 with inner teeth formed on an inner periphery thereof, an outer tooth washer 630 with outer teeth formed on an outer periphery thereof, inner and outer tooth washer 640 with inner and outer teeth formed on inner and outer peripheries thereof, and a disc washer 650 with prominence formed on an outer periphery thereof, are mainly used as washers 40 to prevent the release of the bolts.

As described above, according to the present invention, the motor pulley housing is coupled to the gearbox housing by using the locking washers and the like, thereby making it possible to prevent the release of the bolts and the movement of the motor shaft to the rack bar with the ball nut. Thus, there is an advantage in that it is possible to prevent reduction of tension of the belt and the generation of noise, and prevent the damage to the belt in advance.

Although a preferred embodiment of the present invention has been described for illustrative purposes, those skilled in the art will appreciate that various modifications, additions and substitutions are possible, without departing from the scope and spirit of the invention as disclosed in the accompanying claims.

What is claimed is:

1. A belt type electric power steering apparatus, the apparatus comprising:
a gearbox housing enclosing a rack gear and a ball screw;
a motor pulley housing coupled to the gearbox housing and enclosing an electric motor,
a belt for transmitting rotational force of the electric motor to a rack bar, and
locking washers interposed between bolt heads and the gearbox housing, for preventing loosening of bolts when the motor pulley housing is coupled to the gearbox housing.

2. The belt type electric power steering apparatus as claimed in claim 1, wherein first prominences with a sawtooth shape are formed at both edges of a bolt guide hole of the gearbox housing to which the motor pulley housing is coupled, and wherein square washers are interposed between the bolt heads and the gearbox housing and have second prominences engaged with the first prominences, respectively.

3. The belt type electric power steering apparatus as claimed in claim 1, wherein the locking washer is one of a disc spring washer, a C-shaped spring washer, an outer tooth washer, an inner tooth washer, and a disc washer.

4. The belt type electric power steering apparatus as claimed in claim 2, wherein the locking washer is one of a disc spring washer, a C-shaped spring washer, an outer tooth washer, an inner tooth washer, and a disc washer.
